(19) United States
(12) Patent Application Publication
(10) Pub. No.: US 2006/0059536 A1
(43) Pub. Date: Mar. 16, 2006

(54) Information processing device preinstalled with a program that handles large-capacity data, and method of initializing the information processing device

(75) Inventors: Takahiro Koba, Nagoya (JP); Akihiro Hama, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/016,764

(22) Filed: Dec. 21, 2004

(30) Foreign Application Priority Data
Sep. 10, 2004 (JP) 2004-263698

(51) Int. Cl. H04N 7/173; H04N 7/16

(52) U.S. Cl. 725/142; 725/115; 725/145

(57) ABSTRACT

An information processing device has a first storage area, a second storage area, a folder creating portion, and a mount processing portion. The first storage area stores an operating system and an application program, and the second storage area is different from the first storage area. The folder creating portion creates a first folder that the application program uses, in the first storage area, and the mount processing portion mounts the second storage area on the first folder at the time of initializing the information processing device.

### CROSS REFERENCE TO RELATED APPLICATION

This application is based upon and claims the benefit of priority from the prior Japanese Patent Application No. 2004-263698, filed on Sep. 10, 2004, the entire contents of which are incorporated herein by reference.

### BACKGROUND OF THE INVENTION

1. Field of the Invention

The present invention relates to an information processing device, a method of initializing the information processing device, a computer-readable recording medium recorded with a program, and the program. More particularly, the present invention relates to an information processing device preinstalled with a program that handles large-capacity data, a method of initializing the information processing device (method of initializing an operating system), a computer-readable recording medium recorded with a program (program for initializing an operating system), and the program (program for initializing an operating system).

2. Description of the Related Art

Conventionally, a desktop information processing device for personal use (desktop type personal computer) and a notebook information processing device for personal use (notebook type personal computer) are preinstalled with a predetermined operating system (OS) and various application programs (programs), and are then delivered to users.

In recent years, programs that handle large-capacity data are increasing in number as the programs to be installed. This type of program downloads images and music via the Internet, for example, and records the images and music data into a hard disk drive, or compresses a television broadcast program into MPEG2 files and records the result into the hard disk drive.

When a television broadcast program (television data) is stored into a hard disk drive, this common large-capacity data is often used by plural different programs such as a reproduction program, an editing program, and a writing program to reproduce the data, edit the data, or write the data into an optical disk such as a DVD (digital versatile disk) or the like.

In the prior art, various systems are provided and available to hold data even after carrying out recovery processing. For example, an online transaction processing system having a function of automatically recovering the contents of data even when a trouble occurs in the processing device is proposed. According to this system, data transmitted and received by a client is stored in a file separate from a local domain of an application program, without depending on an application task (refer to Japanese Unexamined Patent Publication (Kokai) No. 2001-184309).

The prior art and its associated problems will be described in detail later with reference to accompanying drawings.

### SUMMARY OF THE INVENTION

According to the present invention, there is provided an information processing device having a first storage area storing an operating system and an application program, and a second storage area different from the first storage area, comprising a folder creating portion creating a first folder that the application program uses, in the first storage area; and a mount processing portion mounting the second storage area on the first folder at the time of initializing the information processing device.

Data processed by a plurality of application programs may be stored into the second storage area mounted on the first folder. The first storage area may be provided in a first hard disk drive, and the second storage area may be provided in a second hard disk drive. The folder creating portion may create a second folder in the first storage area, and store data into the second storage area mounted on the first folder and into the second folder.

The information processing device may further comprise a third storage area provided in the first hard disk drive, wherein the folder creating portion creates a second folder in the first storage area, and the mount processing portion mounts the third storage area on the second folder, and stores data into the second storage area mounted on the first folder and into the third storage area mounted on the second folder. Data processed by a plurality of application programs may stored into the third storage area mounted on the second folder.

The plurality of application programs may include a television broadcast program recording program, a reproduction program, an editing program, and a writing program. The information processing device may further comprise a video processing portion confirming portion confirming whether or not a video processing portion is connected to the information processing device, wherein after the video processing portion confirming portion confirms that the video processing portion is connected to the information processing device, the folder creating portion creates a folder and the mount processing portion carries out mount processing.

Further, according to the present invention, there is provided a method of initializing an information processing device comprising creating a first folder that an application program uses, in a first storage area of an information processing device; and mounting a second storage area of the information processing device on the first folder at the time of initializing the information processing device.

Data processed by a plurality of application programs may be stored into the second storage area mounted on the first folder. The first storage area may be provided in a first hard disk drive, and the second storage area may be provided in a second hard disk drive.

The creating of the first folder may further create a second folder in the first storage area, and data may be stored into the second storage area mounted on the first folder and into the second folder. The creating of the first folder may further create a second folder in the first storage area; and the mounting of the second storage area may further mount a third storage area provided in the first hard disk drive on the second folder, and data are stored into the second storage area mounted on the first folder and into the third storage area mounted on the second folder. Data processed by a plurality of application programs may be stored into the third storage area mounted on the second folder.

The plurality of application programs may include a television broadcast program recording program, a reproduction program, an editing program, and a writing program. The method of initializing an information processing device may further comprise confirming whether or not a video processing portion is connected to the information processing device wherein, after it is confirmed that the video processing portion is connected to the information processing device, a folder is created and the mount processing is carried out.

According to the present invention, there is also provided a computer-readable recording medium recorded with a program for making a computer execute folder create processing for creating a first folder that an application program uses, in a first storage area of an information processing device; and a mount processing of mounting a second storage area of the information processing device on the first folder at the time of initializing the information processing device.

In addition, according to the present invention, there is provided a program for making a computer execute a folder create processing of creating a first folder that an application program uses, in a first storage area of an information processing device; and a mount processing of mounting a second storage area of the information processing device on the first folder at the time of initializing the information processing device.

### BRIEF DESCRIPTION OF THE DRAWINGS

The present invention will be more clearly understood from the description of the preferred embodiments as set forth below with reference to the accompanying drawings, wherein:

FIG. 1A, FIG. 1B, and FIG. 1C are conceptual diagrams of a configuration of partitions of a hard disk drive in a conventional information processing device;

FIG. 2A and FIG. 2B are explanatory diagrams of partitions of a hard disk drive of an information processing device according to a first embodiment of the present invention;

FIG. 3 is a flowchart explaining one example of a method of initializing an operating system of the information processing device shown in FIGS. 2A and 2B;

FIG. 4A and FIG. 4B are explanatory diagrams of partitions of a hard disk drive of an information processing device according to a second embodiment of the present invention;

FIG. 5 is a flowchart explaining one example of a method of initializing an operating system of the information processing device shown in FIGS. 4A and 4B;

FIG. 6A and FIG. 6B are explanatory diagrams of partitions of a hard disk drive of an information processing device according to a third embodiment of the present invention;

FIG. 7 is a flowchart explaining one example of a method of initializing an operating system of the information processing device shown in FIGS. 6A and 6B; and

FIG. 8 is an explanatory diagram of a medium that is recorded with a program for initializing an operating system according to the present invention.

### DESCRIPTION OF THE PREFERRED EMBODIMENTS

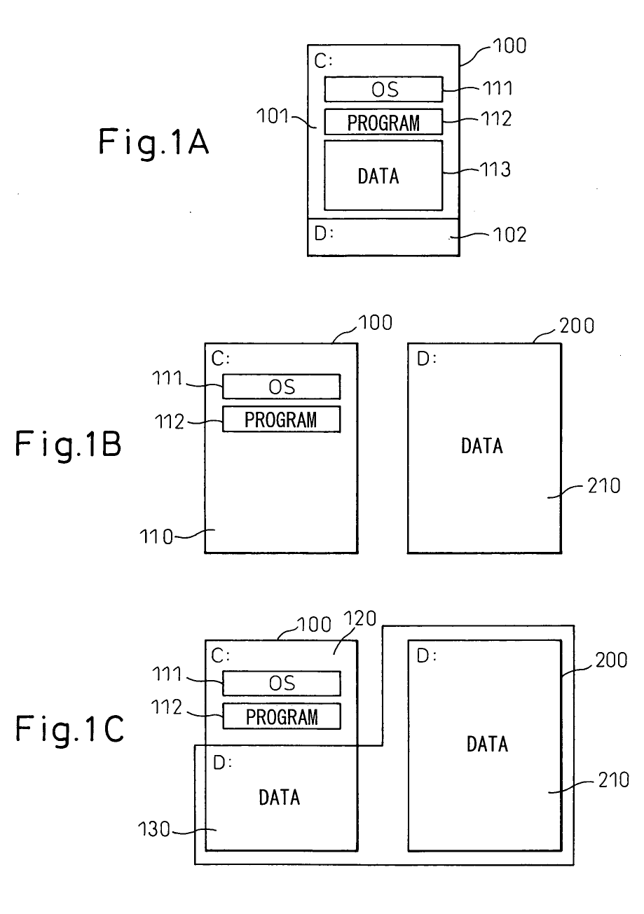

Before proceeding to the detailed description of the preferred embodiments of the present invention, the prior art information processing devices and their problems will be described with reference to FIGS. 1A to 1C.

FIGS. 1A to 1C are conceptual diagrams of a configuration of partitions of a hard disk drive in the conventional information processing device. FIG. 1A shows one example of a configuration of partitions in one hard disk drive. FIGS. 1B and 1C show configurations of partitions in two hard disk drives respectively.

As shown in FIG. 1A, conventionally, a desktop information processing device (desktop computer) or a notebook information processing device (notebook computer) for general personal use has one hard disk drive 100. The one hard disk drive 100 is divided into two partitions or storage areas including a C drive 101 and a D drive 102, for example. The C drive 101 is allocated with an OS (operating system) area 111 for storing an operating system, a program area 112 for storing various application programs, and a data area 13 for storing large-capacity data such as television data that is recorded based on a television broadcast recording program. The D drive 102 is used for a user's backup area, for example.

The program area 112 of the C drive 101 is preinstalled with a television broadcast recording program for recording a television broadcast program into the hard disk drive by compressing the data into MPEG2 files. The data (recorded data of the television broadcast program: television data) recorded according to the television broadcast recording program is stored into the data area 113 of the C drive 101. The program area 112 of the C drive 101 is also preinstalled with a reproduction program for reproducing the recorded data, an editing program for editing the recorded data, and a writing program for writing the data into a DVD using the television broadcast recorded data stored in the data area 113.

FIGS. 1B and 1C are conceptual diagrams showing examples of partition configurations when the information processing device has two hard disk drives of the hard disk drive 100 and a hard disk drive 200. In general, when a hard disk drive of the information processing device consists of two hard disk drives of 200 GB (gigabytes) each, a total cost is lower than that when the hard disk drive consists of one 400 GB hard disk drive.

As shown in FIG. 1B, when the information processing device has the two hard disk drives 100 and 200, usually the first hard disk drive 100 is used for a first partition (C drive) 110, and the second hard disk drive 200 is used for a second partition (D drive) 210. The C drive 110 is allocated with the OS area 111 and the program area 112, and the D drive 210 is allocated with the data area 113, as is known publicly. The user's backup area is allocated to the D drive 210.

Alternatively, as shown in FIG. 1C, when the information processing device has the two hard disk drives 100 and 200, the first hard disk drive 100 is divided into a first partition (C drive: a first storage area) 120 and a second partition (D drive) 130, and the second hard disk drive 200 is used for the second partition (D drive) 210. The D drive 130 of the first hard disk drive 100 and the D drive 210 of the second hard disk drive 200 are controlled as one partition (a second storage area) as is known.

The information processing device shown in FIG. 1A has a problem that the cost of this processing device is higher than the information processing device that has two hard disk drives each having a half capacity. The preinstalled program (application program) data is stored in the same partition as that of the C drive 101 (system partition in which the operating system is stored) set in advance when the program is installed. Therefore, when large-capacity data is stored continuously, this compresses the system partition. When the system operation becomes unstable and a user wants to carry out a recovery processing to recover the state of the system at the purchasing time, the user needs to back up the large-capacity data stored in the system partition into a separate partition or medium. However, when the data to be backed up has a very large capacity like a television broadcast program, the backup time is enormous. The user must be conscious of the capacity of the medium that can store this data.

The information processing devices shown in FIGS. 1B and 1C use the two hard disk drives, each having a half capacity, to constitute one hard disk drive, thereby reducing the cost. According to the information processing device shown in FIG. 1B, when the recovery processing is carried out using the C drive 110, the television broadcast recorded data (television data) that is stored in the D drive 210 can be kept stored as it is.

However, according to the information processing device shown in FIG. 1B, in some cases, plural different programs such as the reproduction program, the editing program, and the writing program are prepared by manufacturers different from a manufacturer of the recording program. In some cases, the recording program cannot refer to the recorded data stored in the D drive 210, unless a special operation is carried out (such as the assignment of a data storage or reference destination) at the time of installing the program. Further, even when the first hard disk drive 100 (C drive 110) has sufficient room in capacity, the second hard disk drive 200 (D drive 210) cannot record additional data when the disk is already fully recorded with data.

According to the information processing device shown in FIG. 1C, the first hard disk drive 100 (D drive 130) and the second hard disk drive 200 (D drive 210) can be sufficiently used to record data. However, when a recovery processing is carried out using the C drive 120, unless a special operation is further carried out, the D drive 130 of the first hard disk drive 100 and the D drive 210 of the second hard disk drive 200 cannot be controlled as one partition.

According to the information processing device shown in FIG. 1B, before the shipment from the plant, it is possible to set such that different plural programs (application programs) are used to store large-capacity data into a common folder provided in a partition of a different hard disk drive (for example, the D drive 210 of the second hard disk drive 200), and that reference destinations of all the programs for referring to the large-capacity data are set in the common folder. However, executing the above setting in the first and the second hard disk drives takes a long time. After carrying out the recovery processing, the initial use status cannot be obtained unless a special operation is carried out.

The present invention has been made in the light of the above problems. It is an object of the present invention to provide an information processing device which can use various programs without requiring a user to carry out a special operation and without giving attention to a data storage position. It is another object of the invention to provide an information processing device that can carry out a recovery processing without requiring the user to be conscious of a data backup.

Below, embodiments of an information processing device, a method of initializing the information processing device, a computer-readable recording medium recorded with a program, and the program according to embodiments of the present invention will be described in detail with reference to the accompanying drawings.

### First Embodiment

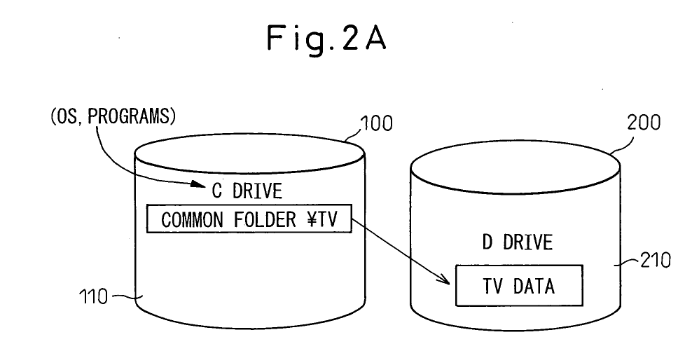

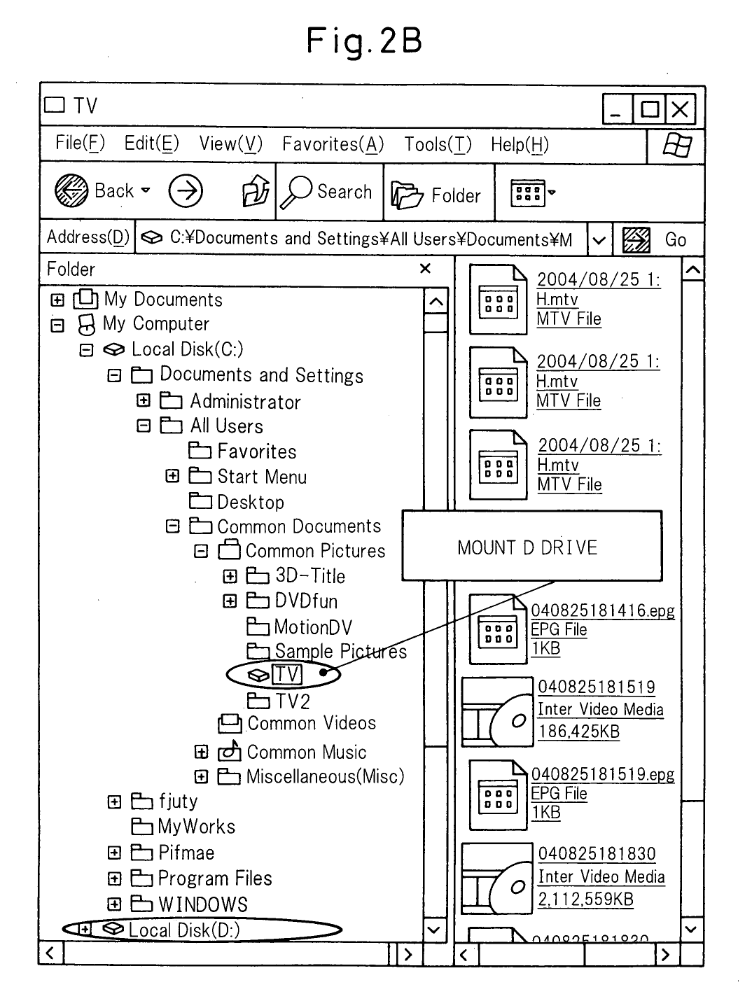

FIGS. 2A and 2B are explanatory diagrams of partitions of a hard disk drive of an information processing device according to a first embodiment of the present invention. FIG. 2A is a conceptual diagram of two hard disk drives, and FIG. 2B is a diagram showing one example of a display image of file management software of an operating system.

As shown in FIG. 2A, the information processing device (computer) according to the first embodiment has the two hard disk drives 100 and 200, each having a half capacity, for example 200 GB, to constitute one hard disk drive of 400 GB, for example, thereby reducing the cost of the information processing device. The information processing device according to the present invention includes an MPU (microprocessor unit), memories, I/O (input/output units), a display, a keyboard, a pointing device, and various peripheral units, in addition to the hard disk drives, as a matter of course.

The first hard disk drive 100 includes one partition (C drive: the first storage area) 110. The C drive 110 has an OS area for storing various operating systems (OS), and a program area for storing various application programs. The second hard disk drive 200 also includes one partition (D drive: the second storage area) 210.

As shown in FIG. 2B, a folder (television folder) containing a television broadcast recording program is formed in a common folder in the C drive 110. The D drive 210 is mounted on the television folder. The D drive 210 is also used for a user's backup area, for example.

As explained above, according to the information processing device of the first embodiment, the television broadcast recording program records a television broadcast program by compressing it into MPEG2 files. When the television broadcast recording program stores the recorded data (television data) into the television folder of the C drive 110, the television data is stored into the D drive 210 (second hard disk drive 100), because the D drive 210 is mounted on the television folder of the common folder in the C drive 110. Further, when the reproduction program, the editing program, or the writing program reproduces, edits, or writes the recorded television data, these programs can access the television data stored in the D drive 210 by referring to the television folder to carry out a predetermined processing, because the D drive 210 is mounted on the television folder of the common folder in the C drive 110.

As explained above, according to the information processing device of the first embodiment of the present invention, when large-capacity data like the television data is mounted on a position (D drive 210) different from the system partition (C drive 110), compression of the system partition due to the increase in the stored data of application programs can be avoided without considering this problem. Each program can execute the reference and storage as usual without considering the data storage position. When the system operation becomes unstable and a user wants to carry out a recovery processing to recover the state of the system at the purchasing time, the user does not need to carry out a backup work, because the television data is stored in the partition (D drive 210) different from the system partition (C drive 110).

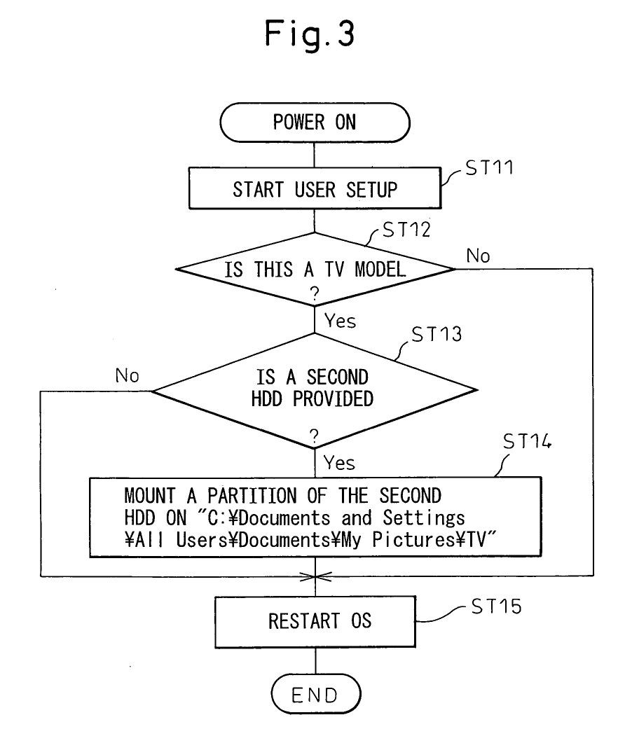

FIG. 3 is a flowchart explaining one example of a method of initializing, i.e., setting up, the operating system of the information processing device shown in FIGS. 2A and 2B.

In FIG. 3, when the power source of the information processing device is turned on for the first time, a user setup is carried up at step ST11. The user setup includes registration of a date and time when the information processing device is started up first, naming the information processing device, registration of the user, and other essential or optional processing. At step ST12, it is decided whether the information processing device is a television model, i.e., a model installed with a television tuner and having a function of receiving a television broadcast program. A decision about whether the information processing device is a television model at step ST12 is made based on whether a television tuner card is mounted on an extension slot, such as a PCI (peripheral component interconnect) bus. When it is, it is decided at step ST12 that the information processing device is a television model

When it is decided at step ST12 that the information processing device is a television model, it is decided at step ST13 whether the second hard disk drive (HDD) 200 is provided. It is needless to mention that the first hard disk drive 100 is essential.

When it is decided at step ST13 that the second hard disk drive 200 is provided, the partition (D drive 210) of the second hard disk drive 200 is mounted on a “C:¥Documents and Settings¥All Users¥Documents¥My Pictures¥TV” folder (corresponding to the television folder shown in FIGS. 2A and 2B, at step ST14. At step ST15, the operating system (OS) is restarted, thereby ending the processing. In this case, the D drive 210 can be mounted on the “C:¥Documents and Settings¥All Users¥Documents¥My Pictures¥TV” folder by using the “disk management” and the command line (DISKPART) in Windows XP (a registered trade name) and Windows 2000 (a registered trademark). Here, in this specification and accompanying drawings, characters used in the operating system may be different among country versions thereof, e.g., the character “¥” may be “\”.

When it is decided at step ST12 that the information processing device is not a television model or when it is decided at step ST13 that the second hard disk drive 200 is not provided, the operating system is restarted at step ST15, thereby ending the processing.

Based on the above processing, a television broadcast recording program is preinstalled, and the “C:¥Documents and Settings¥All Users¥Documents¥My Pictures¥TV” folder is created in the common folder of the C drive 110. The above method of initializing the operating system can be recorded in advance as the operating system initializing program in the hard disk drive of the information processing device.

As described above, when the television broadcast recording program tries to store the recorded data into the television folder of the C drive 110, the recorded data is actually stored into the D drive. When the reproduction program, the editing program or the writing program processes the recorded television data, this program refers to the television folder of the C drive 110 and can access the television data stored in the D drive 210 to carry out the predetermined processing.

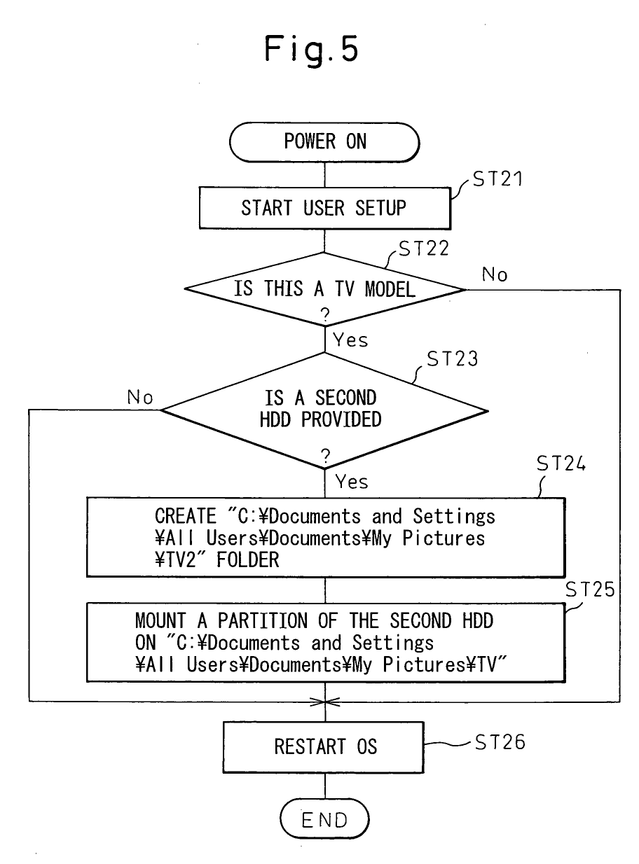

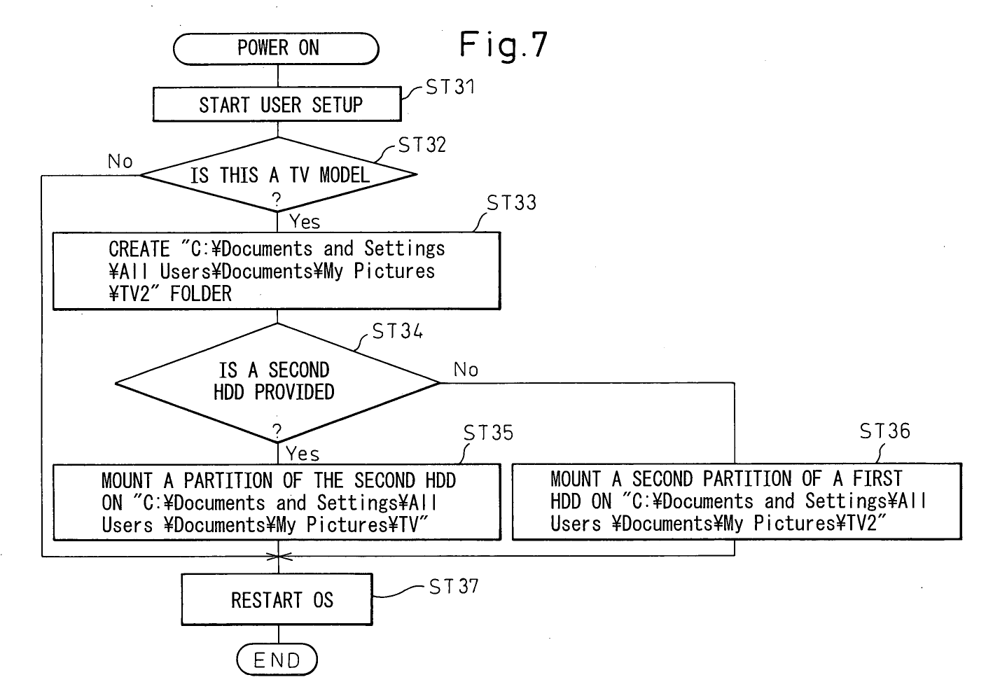

As explained above, according to the first embodiment, the method of initializing the operating system of the information processing device is arranged to mount the D drive 210 on the “C:¥Documents and Settings¥All Users¥Documents¥My Pictures¥TV” folder of the C drive 110 at the time of initializing the operating system. Therefore, it is not necessary to individually carry out this processing for each information processing device in the factory. This similarly applies to the methods of initializing the operating system of the information processing device according to the second embodiment and the third embodiment explained below with reference to FIGS. 5 and 7.

### Second Embodiment

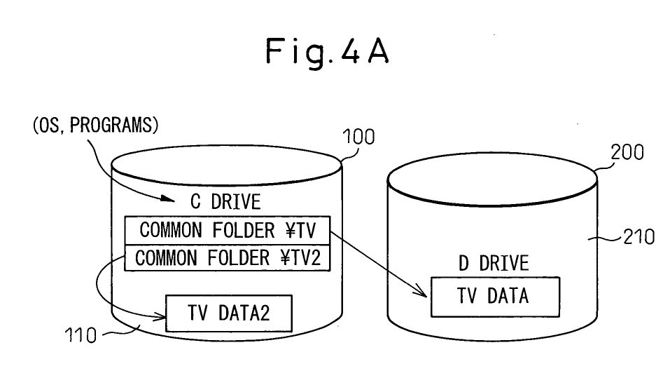

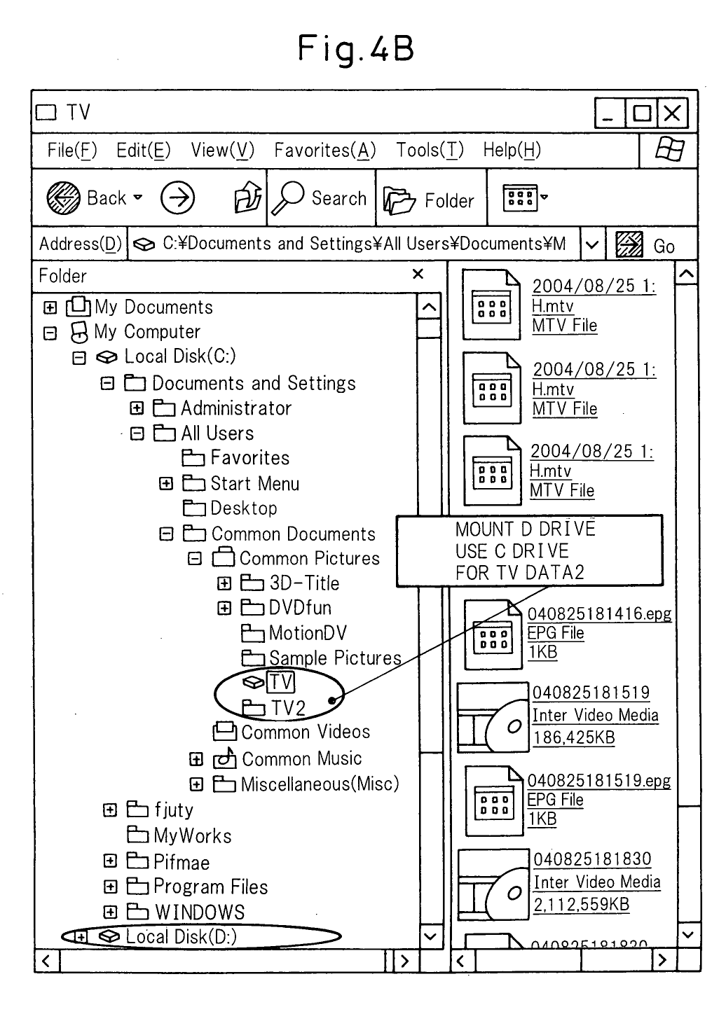

FIGS. 4A and 4B are explanatory diagrams of partitions of a hard disk drive of an information processing device according to the second embodiment of the present invention. FIG. 4A is a conceptual diagram of two hard disk drives, and FIG. 4B is a diagram showing one example of a display image of file management software.

As shown in FIGS. 4A and 4B, the information processing device according to the second embodiment is different from that shown in FIGS. 2A and 2B in that not only the television folder (first folder) but also a television folder (second folder) is provided in the common folder of the first hard disk drive 100 (C drive 110), and that television data (television data 2) is also stored in the second folder.

Based on this arrangement, television data is also stored in the C drive 110. Therefore, the information processing device can carry out recording over a longer time than that according to the first embodiment. When the capacity of the D drive 210 becomes small when an attempt is made to store the television data into the first folder having the capacity equal to that of the D drive 210, the television data 2 is stored into the C drive 110 (second folder). In this case, the user sets the change from the first folder to the second folder.

FIG. 5 is a flowchart explaining one example of a method of initializing the operating system of the information processing device shown in FIGS. 4A and 4B.

In FIG. 5, when the power source of the information processing device is turned on for the first time, a user setup is carried out at step ST21. At step ST22, it is decided whether the information processing device is a television model. To confirm a television tuner card, a device check tool is used to confirm whether a device ID (identification) of the television tuner card is provided. All devices have the device IDs individually. This ID makes it possible to automatically recognize the hardware of the operating system. In general, the device IDs are allocated to television tuner cards in the form of “VEN”+“vendor ID”+“DEV”+“device ID”+“firmware information”. Table 1 below shows a detailed example.

TABLE 1

| Types Of Television Tuner Cards | Device ID |
|---|---|
| Tuner Card Of Extended-Definition | “VEN_1131 & DEV_7133 & |
| TV Manufactured By Company M | SUBSYS_34261461” |
| Tuner Card Of TV Manufactured By | “VEN_10CF & DEV_2011” |
| Company P | |
| Tuner Card Of Notebook TV | “USB¥VID_06B8 & PID_1010” |
| Manufactured By Company M | |
| Tuner Card Of TV Corresponding To | “VEN_4444 & DEV_0016” |
| Special Operating System | |
| Tuner Card Of W-IT Manufactured | “VEN_1131 & DEV_7133 & |
| By Company M | SUBSYS_64281461” |

When it is decided at step ST22 that the information processing device is a television model, it is decided at step ST23 whether the second hard disk drive 200 is provided. When it is decided at step ST23 that the second hard disk drive 200 is provided, a “C:¥Documents and Settings¥All Users¥Documents¥My Pictures¥TV2” folder (corresponding to the television folder (second folder) in FIGS. 4A and 4B) is created in the common folder of the first hard disk drive 100 (C drive 110) at step ST24.

At step ST25, the partition (D drive 210) of the second hard disk drive 200 is mounted on the “C:¥Documents and Settings¥All Users¥Documents¥My Pictures¥TV2” folder. At step ST26, the operating system is restarted, thereby ending the processing.

When it is decided at step ST22 that the information processing device is not a television model or when it is decided at step ST23 that the second hard disk drive 200 is not provided, the operating system is restarted at step ST26, thereby ending the processing.

### Third Embodiment

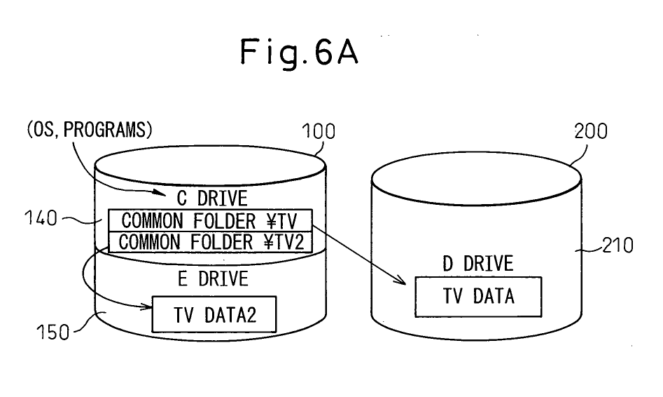

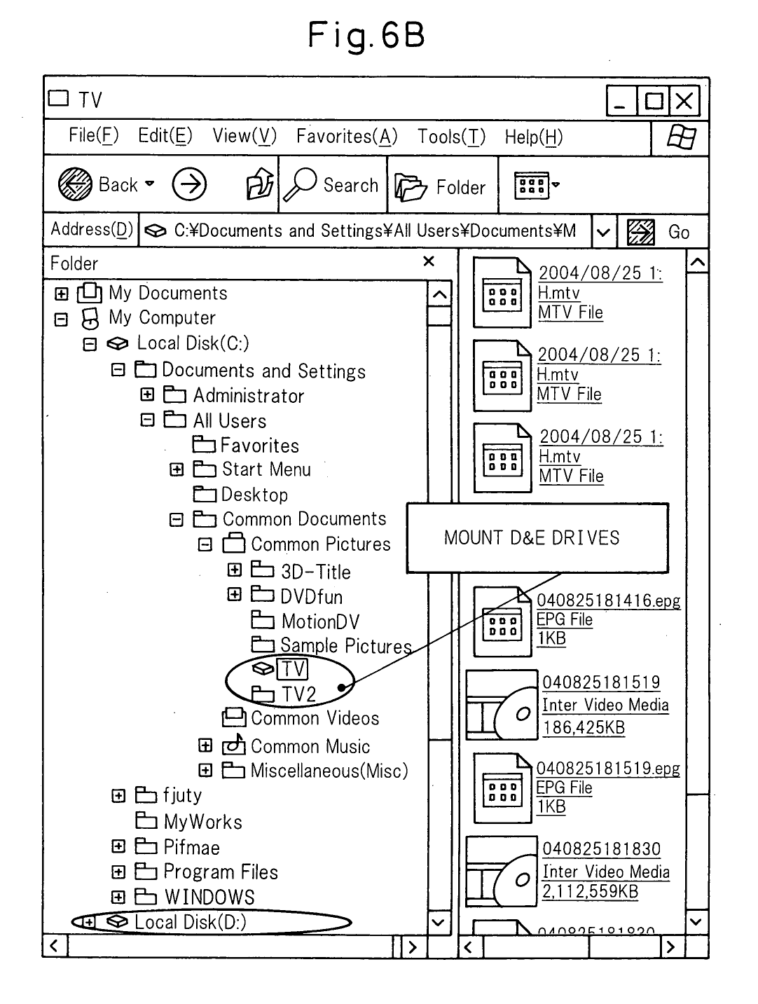

FIGS. 6A and 6B are explanatory diagrams of partitions of a hard disk drive of an information processing device according to the third embodiment of the present invention. FIG. 6A is a conceptual diagram of two hard disk drives, and FIG. 6B is a diagram showing one example of a display image of a file management program.

As shown in FIGS. 6A and 6B, the information processing device according to the third embodiment is different from that shown in FIGS. 4A and 4B as follows. The first hard disk drive 100 is divided into two partitions of a C drive 140 and an E drive 150. The television folder (first folder) and a television 2 folder (second folder) are provided in the common folder of the C drive 140 (first storage area). The D drive 210 (second storage area) is mounted on the first folder, and the E drive 150 (third storage area) is mounted on the second folder.

Based on this arrangement, when the capacity of the D drive 210 becomes small when an attempt is made to store the television data into the first folder having the capacity equal to that of the D drive 210, the television data can be stored into the E drive 150 that is mounted on the second folder. Therefore, the information processing device can carry out recording over a longer time than that according to the second embodiment.

FIG. 7 is a flowchart explaining one example of a method of initializing the operating system of the information processing device shown in FIGS. 6A and 6B.

In FIG. 7, when the power source of the information processing device is turned on for the first time, a user setup is carried out at step ST31. At step ST32, it is decided whether the information processing device is a television model.

When it is decided at step ST32 that the information processing device is a television model, the “C:¥Documents and Settings¥All Users¥Documents¥My Pictures¥TV2” folder (corresponding to the television 2 folder (second folder) in FIGS. 6A and 6B) is created in the common folder of the first partition (C drive 110) of the first hard disk drive 100 at step ST33. At step ST34, it is decided whether the second hard disk drive 200 is provided.

When it is decided at step ST34 that the second hard disk drive 200 is provided, the partition (D drive 210) of the second hard disk drive 200 is mounted on the “C:¥Documents and Settings¥All Users¥Documents¥My Pictures¥TV” folder. At step ST37, the operating system is restarted, thereby ending the processing.

When it is decided at step ST34 that the second hard disk drive 200 is not provided, the second partition (E drive 150) of the first hard disk drive 100 is mounted on the “C:¥Documents and Settings¥All Users¥Documents¥My Pictures¥TV2” folder (second folder) at step ST36. At step ST37, the operating system is restarted, thereby ending the processing.

When it is decided at step ST32 that the information processing device is not a television model, the operating system is restarted at step ST37, thereby ending the processing.

As described in detail above, the information processing devices according the embodiments of the present invention store large-capacity data into a partition other than the system partition mounted in the folder provided in the system partition. Therefore, each application program can refer to or store data into the partition other than the system partition without requiring the user to carry out special processing. Further, when the system recovery processing is carried out, it is not necessary to back up large-capacity data. Further, according to the method of initializing the operating system of the information processing device according to the embodiments of the present invention, a partition other than the system partition is mounted on the folder provided in the system partition, at the time of initializing the operating system. Therefore, in the plant, it is not necessary to individually carry out this mount processing for each information processing device.

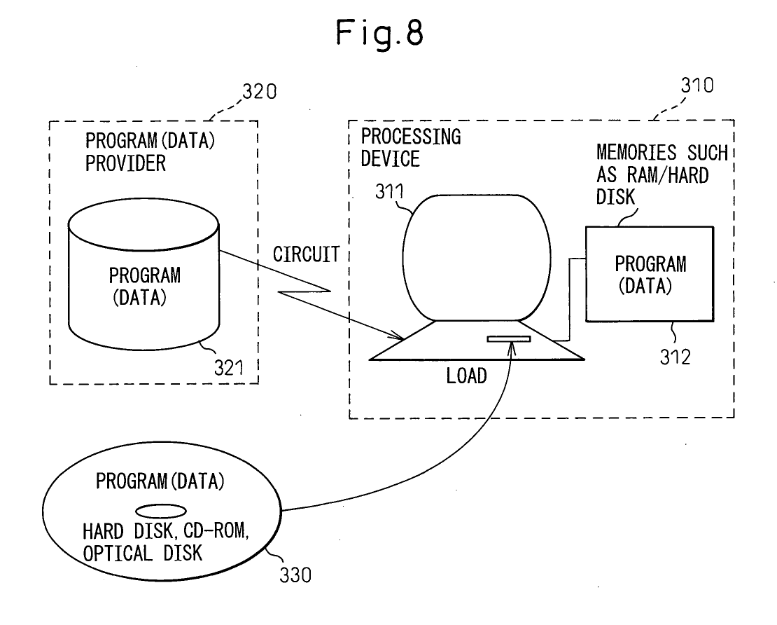

FIG. 8 is an explanatory diagram of a medium that is recorded with the program for initializing the operating system according to the present invention. In FIG. 8, a reference numeral 310 denotes a processing device, 320 denotes a program (data) provider, and 330 denotes a portable recording medium.

The method of initializing the operating system of the information processing device according to the present invention is sent as a program (data) to the processing device 310 shown in FIG. 8, and the program is executed by the processing device 310. The processing device 310 has a processing device main body 311 including a microprocessor unit, and a memory such as an RAM (random access memory) and a hard disk drive 312 that give the program (data) to the processing device main body 311 and store a result of processing. The program (data) given to the processing device 310 is loaded on the processing device, and is executed on the main memory of the processing device 310.

The program (data) provider 320 has a program (data) storage (circuit destination memory: for example, a DASD (direct access storage device)) 321. The program provider 320 provides the program (data) to the processing device 310 via a circuit such as the Internet, or via the portable recording medium 330 such as a hard disk, a CD-ROM (compact disk read-only memory), an optical disk, and a floppy disk. The medium recorded with the program for initializing the operating system according to the present invention includes, needless to mention, the memory 312, the circuit destination memory 321, and the portable recording medium 330. When the information processing device according to the present invention is the processing device 310, the medium recorded with the program for initializing the operating system can be the hard disk drive 312 that is recorded with the operating system preinstalled at the plant and various application programs.

In the above explanation, the large-capacity data is not limited to the television broadcast recorded data, but can be images, music data, and other data downloaded via the Internet. Various application programs are also available corresponding to these data. The number of hard disk drives is not limited to two. Needless to mention, the present invention can be also applied to one hard disk drive provided with plural partitions or to three or more hard disk drives.

As described above, according to the present invention, it is possible to provide the information processing device which can use various programs without requiring a user to carry out a special operation and without giving attention to a data storage position. It is also possible to provide the information processing device that can carry out a recovery processing without requiring the user to be conscious of a data backup.

The present invention can be applied to various information processing devices including desktop and notebook information processing devices for personal use preinstalled with an operating system and plural application programs. Particularly, the present invention is suitable for information processing devices that store and refer to large-capacity data using plural different application programs.

Many different embodiments of the present invention may be constructed without departing from the scope of the present invention, and it should be understood that the present invention is not limited to the specific embodiments described in this specification, except as defined in the appended claims.

What is claimed is:

1. An information processing device having a first storage area storing an operating system and an application program, and a second storage area different from the first storage area, comprising:
a folder creating portion creating a first folder that the application program uses, in the first storage area; and
a mount processing portion mounting the second storage area on the first folder at the time of initializing the information processing device.

2. The information processing device as claimed in claim 1, wherein:
data processed by a plurality of application programs are stored into the second storage area mounted on the first folder.

3. The information processing device as claimed in claim 2, wherein:
the plurality of application programs include a television broadcast program recording program, a reproduction program, an editing program, and a writing program.

4. The information processing device as claimed in claim 3, further comprising:
a video processing portion confirming portion confirming whether or not a video processing portion is connected to the information processing device, wherein after the video processing portion confirming portion confirms that the video processing portion is connected to the information processing device, the folder creating portion creates a folder and the mount processing portion carries out a mount processing.

5. The information processing device as claimed in claim 1, wherein:
the first storage area is provided in a first hard disk drive, and the second storage area is provided in a second hard disk drive.

6. The information processing device as claimed in claim 5, wherein:
the folder creating portion creates a second folder in the first storage area, and stores data into the second storage area mounted on the first folder and into the second folder.

7. The information processing device as claimed in claim 5, further comprising:
a third storage area provided in the first hard disk drive, wherein the folder creating portion creates a second folder in the first storage area, and the mount processing portion mounts the third storage area on the second folder, and stores data into the second storage area mounted on the first folder and into the third storage area mounted on the second folder.

8. The information processing device as claimed in claim 7, wherein:
data processed by a plurality of application programs are stored into the third storage area mounted on the second folder.

9. The information processing device as claimed in claim 8, wherein:
the plurality of application programs include a television broadcast program recording program, a reproduction program, an editing program, and a writing program.

10. The information processing device as claimed in claim 9, further comprising:
a video processing portion confirming portion confirming whether or not a video processing portion is connected to the information processing device, wherein after the video processing portion confirming portion confirms that the video processing portion is connected to the information processing device, the folder creating portion creates a folder and the mount processing portion carries out mount processing.

11. A method of initializing an information processing device comprising:
creating a first folder that an application program uses, in a first storage area of an information processing device; and
mounting a second storage area of the information processing device on the first folder at the time of initializing the information processing device.

12. The method of initializing an information processing device as claimed in claim 11, wherein:
data processed by a plurality of application programs are stored into the second storage area mounted on the first folder.

13. The method of initializing an information processing device as claimed in claim 12, wherein:
the plurality of application programs include a television broadcast program recording program, a reproduction program, an editing program, and a writing program.

14. The method of initializing an information processing device as claimed in claim 13, further comprising:
confirming whether or not a video processing portion is connected to the information processing device, wherein after it is confirmed that the video processing portion is connected to the information processing device, a folder is created and the mount processing is carried out.

15. The method of initializing an information processing device as claimed in claim 11, wherein:
the first storage area is provided in a first hard disk drive, and the second storage area is provided in a second hard disk drive.

16. The method of initializing an information processing device as claimed in claim 15, wherein:
the creating of the first folder further creates a second folder in the first storage area, and data are stored into the second storage area mounted on the first folder and into the second folder.

17. The method of initializing an information processing device as claimed in claim 15, wherein:
the creating of the first folder further creates a second folder in the first storage area; and
the mounting of the second storage area further mounts a third storage area provided in the first hard disk drive on the second folder, and data are stored into the second storage area mounted on the first folder and into the third storage area mounted on the second folder.

18. The method of initializing an information processing device as claimed in claim 17, wherein:
data processed by a plurality of application programs are stored into the third storage area mounted on the second folder.

19. The method of initializing an information processing device as claimed in claim 18, wherein:
the plurality of application programs include a television broadcast program recording program, a reproduction program, an editing program, and a writing program.

20. The method of initializing an information processing device as claimed in claim 19, further comprising:
confirming whether or not a video processing portion is connected to the information processing device wherein, after it is confirmed that the video processing portion is connected to the information processing device, a folder is created and the mount processing is carried out.

21. A computer-readable recording medium recorded with a program for making a computer execute:
folder create processing for creating a first folder that an application program uses, in a first storage area of an information processing device; and
a mount processing of mounting a second storage area of the information processing device on the first folder at the time of initializing the information processing device.

22. A program for making a computer execute:
a folder create processing of creating a first folder that an application program uses, in a first storage area of an information processing device; and
a mount processing of mounting a second storage area of the information processing device on the first folder at the time of initializing the information processing device.
